(19) United States
(12) Patent Application Publication
(10) Pub. No.: US 2024/0386379 A1
(43) Pub. Date: Nov. 21, 2024

(54) MATERIAL FINALIZATION FOR AN ONLINE MEETING

(71) Applicant: Lenovo (Singapore) Pte. Ltd., Singapore (SG)

(72) Inventors: Fred Allison Bower, III, Durham, NC (US); Michaela Cameron, Morrisville, NC (US)

(21) Appl. No.: 18/320,561

(22) Filed: May 19, 2023

(51) Int. Cl. G06Q 10/10; G06Q 10/1093

(52) U.S. Cl. CPC G06Q 10/103; G06Q 10/1095

(57) ABSTRACT

A system to finalize material for an online meeting receives a request from a meeting organizer to schedule an online meeting. The request includes a list of meeting attendees. An invitation is transmitted to the meeting attendees. The invitation includes a request for material to be used in connection with the online meeting. The material for use in connection with the online meeting is received from the meeting attendees. The meeting attendees are allowed to modify the material prior to the online meeting. A blackout period is established prior to the online meeting during which the attendees cannot modify the material. Thereafter, the material is made available during the online meeting.

### TECHNICAL FIELD

Embodiments described herein generally relate to online meetings, and in an embodiment, but not by way of limitation, providing a system for creating, managing, reviewing and storing content to be used during an online meeting.

### BACKGROUND

In global organizations, it is often desired to have meeting materials translated or otherwise finalized prior to an actual meeting. However, the typical practice of meeting presenters bringing material to the actual meeting prevents effective enforcement of the finalization of the meeting materials. Further, it is often desired that materials be revised after the meeting, often with re-presentation in a subsequent session, which can stretch into a series of meetings.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1A and 1B are a block diagram of operations and features of a system and method for creating, managing, reviewing and storing content to be used during an online meeting.

FIG. 2 is a block diagram of a computer architecture upon which one or more of the embodiments disclosed herein can execute.

### DETAILED DESCRIPTION

Currently, meeting organizers can request that presentation materials be submitted beforehand and then present those materials from the submission site. However, this requires the meeting organizer to maintain a historical archive. Existing collaboration tools do not implement any automation of this archiving process beyond posting of files with the meeting minutes. Moreover, meeting organizers often need to do some preparation based upon finalized material to be presented such as translation, distribution to external attendees and legal review. Collaboration tools today lack formal mechanisms to “lock” content and maintain a succinct record of as-presented material.

An embodiment enables a full history of presentations and other material for an online meeting, with control over the material in a black-out or lock-out period prior to the actual online meeting. This is accomplished applying a document control system of sorts to online office collaboration tools. An embodiment integrates a content-control subsystem into existing meeting collaboration tools to enable different roles for content curation. It provides new capabilities for a meeting organizer, and it further provides new roles in general such as a content manager, a content creator and a content reviewer. Another embodiment automates the publication of meeting elements based upon specified parameters and role permissions.

Consequently, in an embodiment, when a meeting is scheduled using an online meeting tool, such as Microsoft Teams, the presenters in the meeting are prompted for material to be used during the meeting in the meeting invitation. This provides an extended role over existing meeting invitation semantics. The presenter is allowed to post and edit content for the meeting presentation, and the organizer of the meeting establishes finalization criteria for the presentation material. To implement this, the system generates a set of prompts and lockouts associated with the presenter's ability to submit and alter content. The meeting scheduling/office collaboration software automatically logs the “locked presentation” content with the meeting minutes and with the optional ability to link to future revisions of the content.

More specifically, in an embodiment, the meeting organizer is the content curator by default, but this role could be delegated. The meeting organizer can also designate presenter(s), the content to be provided, a window of editing permission, a window of viewing availability by one or more reviewers, and attendee roles. In an educational environment, the embodiment can be used for submission of assignments or exam materials. In a commercial or business environment, the embodiment can be used for deadline-based submission of content. Also, artifacts of record can be created for archival purposes.

A presenter, who can be designated by the content curator, can create and modify content for the meeting record. Pre-meeting material can be posted for review, consideration and modification in a workshop. When material is submitted for review by one or more reviewers, it can be protected via a read-only access mechanism using optionally different schedules from other attendees and with the ability to provide annotated comments to the provider of the content (presenter). The one or more reviewers can of course revise the material, provide feedback prior to the presentation or meeting, and approve the content of the material for presentation.

Normally, an attendee has only read-only access to content based upon content curator (meeting organizer) policies. The access history of the content with changes highlighted can be provided to the attendees (and others). Another embodiment utilizes existing source/revision control systems to implement these disclosed features in an online meeting organization system. In yet another embodiment, the system integrates a document or version control for audit functionality in a collaboration toolset.

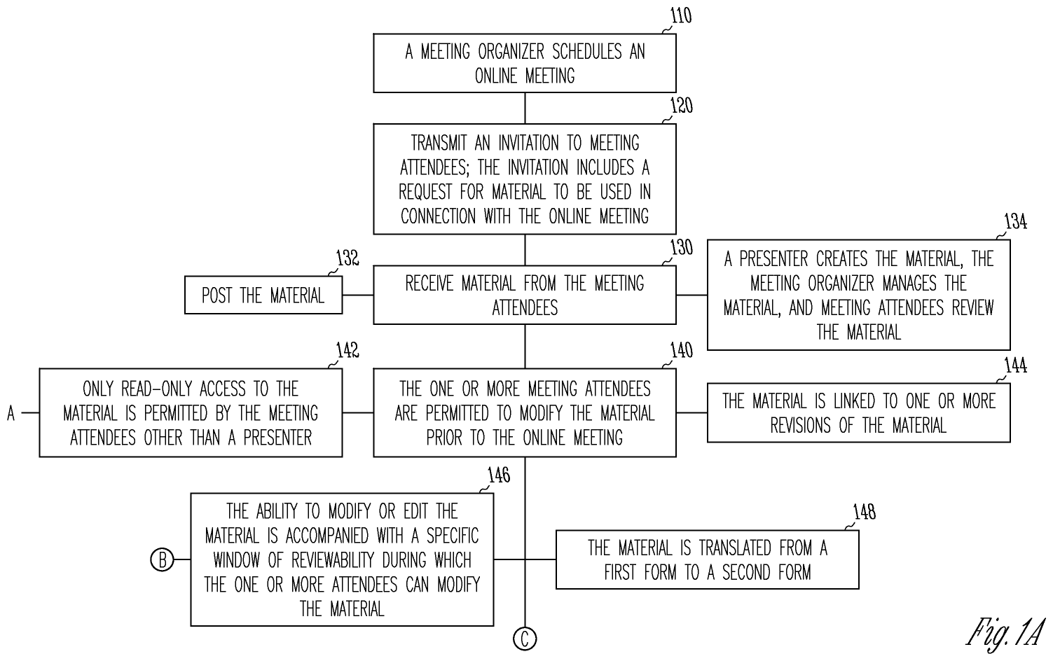

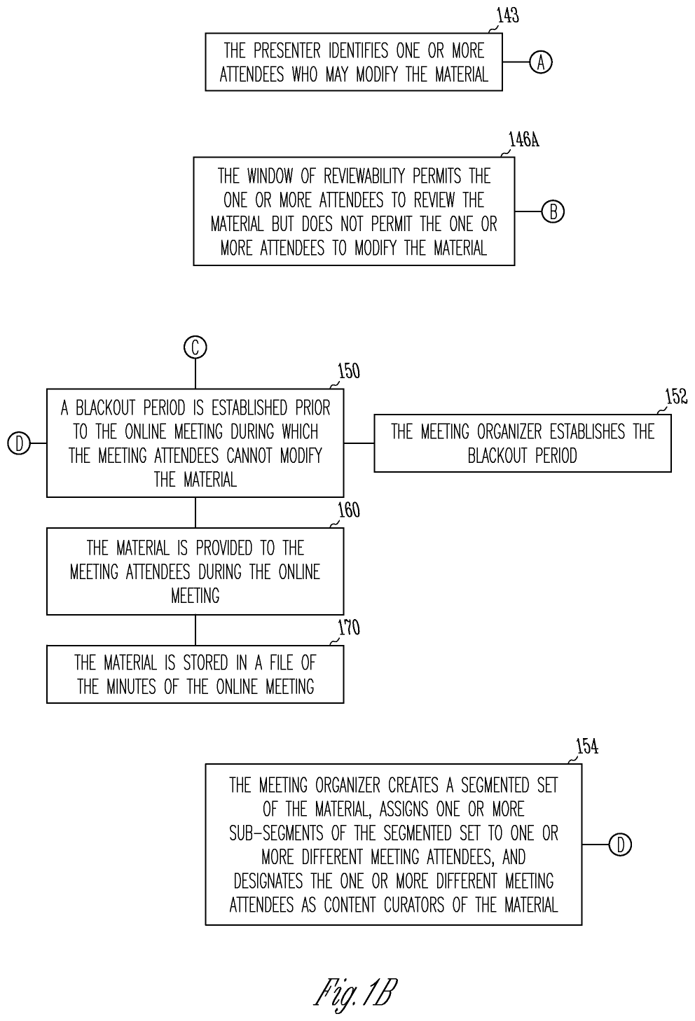

FIGS. 1A and 1B are a block diagram illustrating example embodiments of operations and features of a system and method for finalizing material to be used in connection with an online meeting. FIGS. 1A and 1B include a number of process and feature blocks 110-170. Though arranged substantially serially in the example of FIGS. 1A and 1B, other examples may reorder the blocks, omit one or more blocks, and/or execute two or more blocks in parallel using multiple processors or a single processor organized as two or more virtual machines or sub-processors.

Referring now specifically to FIGS. 1A and 1B, at 110, a request is received from a meeting organizer to schedule an online meeting. The request includes a list of meeting attendees. At 120, an invitation is transmitted to the meeting attendees. The invitation includes a request for material to be used in connection with the online meeting.

At 130, material is received from one or more of the meeting attendees. The material is for use in connection with the online meeting. As indicated at 132, the material can be posted. The posting permits the meeting attendees to have access to the material for review, editing and other reasons. This posting can take place throughout the preparation of the meeting preparation process, even during a blackout period (but as described below no editing can occur during the blackout period). As indicated at 134, in an embodiment, a presenter creates the material, the meeting organizer manages the material, and the one or more meeting attendees review the material.

At 140, the one or more meeting attendees are permitted to modify the material prior to the online meeting. As noted at 142, in an embodiment, the system permits only read-only access to the material by the meeting attendees other than a presenter. As indicated at 144, the material can be linked to one or more revisions of the material. This linking establishes a revision history of the material, which can be examined if needed to address any issues in the content of the material. In another embodiment however, as indicated at 143, the presenter identifies one or more attendees who may modify the material. Throughout this editing and modification process, the material can be linked to one or more revisions of the material, thereby creating a revision history of the material. As indicated at 146, this ability to modify or edit the material can be accompanied within a specific window of reviewability during which the one or more attendees can modify the material. This window of reviewability can be used to implement other features, such as withholding an identity of a person who is to receive some special award or recognition (i.e., a “big reveal”). In another embodiment, as indicated at 146A, the window of reviewability permits the one or more attendees to review the material, but it does not permit the one or more attendees to modify the material. For example, attendees may not be allowed to modify the material if they are evaluating the material but they are not intending to contribute to the content of the material. This may be particularly pertinent in the situation of an evaluation of online scholastic work, wherein an assignment has to be prepared by the presenter (student) and can then be reviewed (either by other students or an instructor) prior to revision and resubmission. The system can permit any type of editing or modification, but in a particular embodiment, as indicated at 148, the material is translated from a first form to a second form, such as translation from a first language into a second language. This feature is particularly useful in view of the international business conducted by multinational corporations. Other translations can include for example graphics annotations or transformation for vision impaired attendees.

At 150, a blackout period is established prior to the online meeting during which the one or more attendees cannot modify the material. As indicated at 152, the meeting organizer establishes the blackout period. However, in other embodiments, a presenter or other meeting attendee can establish the blackout period. In another embodiment, the meeting organizer can designate one or more of the attendees as content curators of the material (154). In this embodiment, the meeting organizer may simply set up the online meeting, but then delegate the establishment of blackout periods and the identification of reviewers, content creators, and others to another.

At 160, the material is provided to the meeting attendees during the online meeting. In an embodiment, at 170, the material can be stored in a file of the minutes of the online meeting.

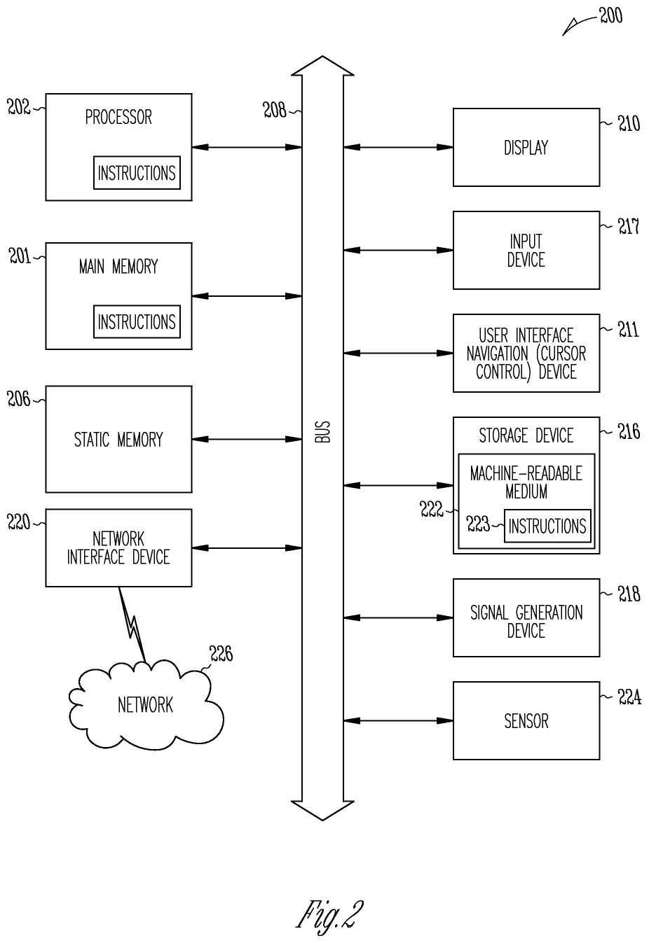

FIG. 2 is a block diagram illustrating a computing and communications platform 200 in the example form of a general-purpose machine on which some or all the operations of FIGS. 1A and 1B may be carried out according to various embodiments. In certain embodiments, programming of the computing platform 200 according to one or more particular algorithms produces a special-purpose machine upon execution of that programming. In a networked deployment, the computing platform 200 may operate in the capacity of either a server or a client machine in server-client network environments, or it may act as a peer machine in peer-to-peer (or distributed) network environments.

Example computing platform 200 includes at least one processor 202 (e.g., a central processing unit (CPU), a graphics processing unit (GPU) or both, processor cores, compute nodes, etc.), a main memory 201 and a static memory 206, which communicate with each other via a link 208 (e.g., bus). The computing platform 200 may further include a video display unit 210, input devices 217 (e.g., a keyboard, camera, microphone), and a user interface (UI) navigation device 211 (e.g., mouse, touchscreen). The computing platform 200 may additionally include a storage device 216 (e.g., a drive unit), a signal generation device 218 (e.g., a speaker), a sensor 224, and a network interface device 220 coupled to a network 226.

The storage device 216 includes a non-transitory machine-readable medium 222 on which is stored one or more sets of data structures and instructions 223 (e.g., software) embodying or utilized by any one or more of the methodologies or functions described herein. The instructions 223 may also reside, completely or at least partially, within the main memory 201, static memory 206, and/or within the processor 202 during execution thereof by the computing platform 200, with the main memory 201, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 223. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A.” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process for receiving a request from a meeting organizer to schedule an online meeting, the request comprising a list of meeting attendees; transmitting an invitation to the meeting attendees, the invitation comprising a request for material to be used in connection with the online meeting; receiving from one or more of the meeting attendees the material for use in connection with the online meeting; permitting the one or more meeting attendees to modify the material prior to the online meeting; establishing a blackout period prior to the online meeting during which the one or more attendees cannot modify the material; providing the material during the online meeting; and storing the material in a file comprising minutes of the online meeting.

Example No. 2 includes all the features of Example No. 1 and optionally includes a process for receiving a request to post the material from the one or more attendees; and posting the material.

Example No. 3 includes all the features of Example Nos. 1-2 and optionally includes a process wherein the meeting organizer establishes the blackout period.

Example No. 4 includes all the features of Example Nos. 1-3 and optionally includes a process wherein the meeting organizer creates a segmented set of the material, assigns one or more sub-segments of the segmented set to one or more different meeting attendees, and designates the one or more different meeting attendees as content curators of the material. This example can be referred to as a classroom assignment model wherein there are multiple content curators, each curating a subset of the online meeting content. The meeting organizer can create a segmented set of material and assign sub-segments to different content creators and reviewers.

Example No. 5 includes all the features of Example Nos. 1-4 and optionally includes a process comprising linking the material to one or more revisions of the material.

Example No. 6 includes all the features of Example Nos. 1-5 and optionally includes a process comprising storing a plurality of versions of the material, thereby creating a change history of the material.

Example No. 7 includes all the features of Example Nos. 1-6 and optionally includes a process comprising allowing read-only access to the material by the meeting attendees other than a presenter.

Example No. 8 includes all the features of Example Nos. 1-7 and optionally includes a process comprising receiving a message from the presenter identifying one or more attendees who may modify the material.

Example No. 9 includes all the features of Example Nos. 1-8 and optionally includes a process comprising establishing a window of reviewability during which the one or more attendees can modify the material.

Example No. 10 includes all the features of Example Nos. 1-9 and optionally includes a process comprising establishing a window of reviewability during which the one or more attendees can review the material but are not permitted to modify the material.

Example No. 11 includes all the features of Example Nos. 1-10 and optionally includes a process wherein a presenter creates the material, the meeting organizer manages the material, and the one or more meeting attendees review the material.

Example No. 12 includes all the features of Example Nos. 1-11 and optionally includes a process wherein the modifying comprises a translation of the material from a first form to a second form.

Example No. 13 is a machine-readable medium comprising instructions that when executed by a processor execute a process comprising receiving into a computer processor a request from a meeting organizer to schedule an online meeting, the request comprising a list of meeting attendees; transmitting an invitation to the meeting attendees, the invitation comprising a request for material to be used in connection with the online meeting; receiving from one or more of the meeting attendees the material for use in connection with the online meeting; permitting the one or more meeting attendees to modify the material prior to the online meeting; establishing a blackout period prior to the online meeting during which the one or more attendees cannot modify the material; providing the material during the online meeting; and storing the material in a file comprising minutes of the online meeting.

Example No. 14 includes all the features of Example No. 13 and optionally includes a machine-readable medium comprising instructions for linking the material to one or more revisions of the material.

Example No. 15 includes all the features of Example Nos. 13-14 and optionally includes a machine-readable medium comprising instructions for storing a plurality of versions of the material, thereby creating a change history of the material.

Example No. 16 includes all the features of Example Nos. 13-15 and optionally includes a machine-readable medium comprising instructions for allowing read-only access to the material by the meeting attendees other than a presenter; and for receiving a message from the presenter identifying one or more attendees who may modify the material.

Example No. 17 includes all the features of Example Nos. 13-16 and optionally includes a machine-readable medium comprising instructions for establishing a window of reviewability during which the one or more attendees can modify the material.

Example No. 18 includes all the features of Example Nos. 13-17 and optionally includes a machine-readable medium comprising instructions for establishing a window of reviewability during which the one or more attendees can review the material but are not permitted to modify the material.

Example No. 19 includes all the features of Example Nos. 13-18 and optionally includes a machine-readable medium wherein the modifying comprises instructions for translating the material from a first form to a second form.

Example No. 20 is a system comprising a processor; and a memory coupled to the processor; wherein the processor and memory are operable for receiving into a computer processor a request from a meeting organizer to schedule an online meeting, the request comprising a list of meeting attendees; transmitting an invitation to the meeting attendees, the invitation comprising a request for material to be used in connection with the online meeting; receiving from one or more of the meeting attendees the material for use in connection with the online meeting; permitting the one or more meeting attendees to modify the material prior to the online meeting; establishing a blackout period prior to the online meeting during which the one or more attendees cannot modify the material; providing the material during the online meeting; and storing the material in a file comprising minutes of the online meeting.

1. A process comprising:
receiving into a computer processor a request from a meeting organizer to schedule an online meeting, the request comprising a list of meeting attendees;
transmitting an invitation to the meeting attendees, the invitation comprising a request for material to be used in connection with the online meeting;
receiving from one or more of the meeting attendees the material for use in connection with the online meeting;
permitting the one or more meeting attendees to modify the material prior to the online meeting;
establishing a blackout period prior to the online meeting during which the one or more attendees cannot modify the material;
providing the material during the online meeting; and
storing the material in a file comprising minutes of the online meeting.

2. The process of claim 1, comprising:
receiving a request to post the material from the one or more attendees; and
posting the material.

3. The process of claim 1, wherein the meeting organizer establishes the blackout period.

4. The process of claim 1, wherein the meeting organizer creates a segmented set of the material, assigns one or more sub-segments of the segmented set to one or more different meeting attendees, and designates the one or more different meeting attendees as content curators of the material.

5. The process of claim 1, comprising linking the material to one or more revisions of the material.

6. The process of claim 1, comprising storing a plurality of versions of the material, thereby creating a change history of the material.

7. The process of claim 1, comprising allowing read-only access to the material by the meeting attendees other than a presenter.

8. The process of claim 7, comprising receiving a message from the presenter identifying one or more attendees who may modify the material.

9. The process of claim 1, comprising establishing a window of reviewability during which the one or more attendees can modify the material.

10. The process of claim 1, comprising establishing a window of reviewability during which the one or more attendees can review the material but are not permitted to modify the material.

11. The process of claim 1, wherein a presenter creates the material, the meeting organizer manages the material, and the one or more meeting attendees review the material.

12. The process of claim 1, wherein the modifying comprises a translation of the material from a first form to a second form.

13. A non-transitory machine-readable medium comprising instructions that when executed by a processor execute a process comprising:
receiving into a computer processor a request from a meeting organizer to schedule an online meeting, the request comprising a list of meeting attendees;
transmitting an invitation to the meeting attendees, the invitation comprising a request for material to be used in connection with the online meeting;
receiving from one or more of the meeting attendees the material for use in connection with the online meeting;
permitting the one or more meeting attendees to modify the material prior to the online meeting;
establishing a blackout period prior to the online meeting during which the one or more attendees cannot modify the material;
providing the material during the online meeting; and
storing the material in a file comprising minutes of the online meeting.

14. The non-transitory machine-readable medium of claim 13, comprising instruction for linking the material to one or more revisions of the material.

15. The non-transitory machine-readable medium claim 13, comprising instruction for storing a plurality of versions of the material, thereby creating a change history of the material.

16. The non-transitory machine-readable medium of claim 13, comprising instructions for allowing read-only access to the material by the meeting attendees other than a presenter; and for receiving a message from the presenter identifying one or more attendees who may modify the material.

17. The non-transitory machine-readable medium of claim 13, comprising instructions for establishing a window of reviewability during which the one or more attendees can modify the material.

18. The non-transitory machine-readable medium of claim 13, comprising instructions for establishing a window of reviewability during which the one or more attendees can review the material but are not permitted to modify the material.

19. The non-transitory machine-readable medium of claim 13, wherein the modifying comprises instructions for translating the material from a first form to a second form.

20. A system comprising:
a processor; and
a memory coupled to the processor;
wherein the processor and memory are operable for:
receiving into a computer processor a request from a meeting organizer to schedule an online meeting, the request comprising a list of meeting attendees;
transmitting an invitation to the meeting attendees, the invitation comprising a request for material to be used in connection with the online meeting;
receiving from one or more of the meeting attendees the material for use in connection with the online meeting;
permitting the one or more meeting attendees to modify the material prior to the online meeting;
establishing a blackout period prior to the online meeting during which the one or more attendees cannot modify the material;
providing the material during the online meeting; and
storing the material in a file comprising minutes of the online meeting.
